(19) United States
(12) Patent Application Publication
(10) Pub. No.: US 2026/0291073 A1
(43) Pub. Date: Sep. 24, 2026

(54) Wire Dipole Antenna for 75-Meter High-Frequency Radio Applications with Low Apex Height

(71) Applicant: James David Armstrong, JR., San Jose, CA (US)

(72) Inventor: James David Armstrong, JR., San Jose, CA (US)

(21) Appl. No.: 19/087,473

(22) Filed: Mar. 22, 2025

(51) Int. Cl. H01Q 9/44

(52) U.S. Cl. CPC H01Q 9/44

(57) ABSTRACT

A wire dipole antenna system for 75-meter high-frequency (HF) radio applications is disclosed, configured to operate effectively at low apex heights relative to ground level. The antenna comprises a center-fed dipole constructed of conductive wire elements of specific length and orientation to facilitate efficient radiation and impedance characteristics under low-elevation deployment conditions. The design optimizes near-vertical incidence skywave (NVIS) propagation and addresses challenges associated with limited antenna height, such as impedance mismatch and ground losses. The system enables practical installation in environments with vertical space constraints while maintaining performance suitable for HF communication. Most importantly, the system does not require impedance matching devices including inductance and capacitance networks.

### FIELD OF THE INVENTION

The present invention relates to antennas, and more specifically to a wire dipole antenna designed specifically for 75-meter high-frequency (HF) radio applications. The invention provides a novel configuration that minimizes the apex height of the antenna while optimizing performance within the 75-meter band. The antenna is designed to be used in various radio communication systems where low apex height and efficient radiation over a specified frequency range are critical.

### BACKGROUND OF THE INVENTION

Wire dipole antennas are commonly used in high-frequency radio communications, particularly for their simplicity and reliability. However, many existing designs for 75-meter antennas require large vertical structures or high apex heights to achieve resonant frequencies. This presents installation challenges, particularly in areas with height limitations or when operating within confined spaces.

The present invention addresses this issue by providing a wire dipole antenna specifically optimized for the 75-meter band, with a novel low apex height of 15 feet, corresponding to 1/16 wavelength at 3.900 MHz. This novel design provides efficient performance while being compact and easy to install in constrained environments.

### SUMMARY OF THE INVENTION

The present invention provides a wire dipole antenna designed exclusively for the 75-meter band, operating efficiently at 3.900 MHz. The antenna utilizes a low apex height of 15 feet, which corresponds to 1/16 of the wavelength at the operating frequency, resulting in a compact design that is suitable for installations where height is a limiting factor.

The antenna consists of a centrally-fed dipole structure with two symmetrical wire elements that extend from the central insulator. The antenna's design minimizes physical space requirements without sacrificing performance, providing high efficiency in the 75-meter frequency range (3.8 MHz to 4.0 MHz).

Additionally, the antenna incorporates insulators to terminate the wire elements at their ends, where secure tie-downs can be made with ease, providing simplicity and robustness in deployment.

### BRIEF DESCRIPTION OF THE DRAWINGS

FIG. 1A—An illustration of the wire dipole antenna showing the center insulator, with its apex at 15 feet.

FIG. 1B—A detailed view of the antenna's first wire element with the terminating insulator, to which the RG8X coaxial braid is attached.

FIG. 1C—A diagram of the antenna system with the terminating insulator, coax center conductor feeding the central feed point.

FIG. 1D—A diagram of the antenna system's coaxial cable, part number RG8X

FIG. 1E—A diagram of the antenna's first of two wire elements (L1), with an overall length of sixty feet (60′).

FIG. 1F—A diagram of the antenna's second of two wire elements (L2), with an overall length of sixty feet (60′).

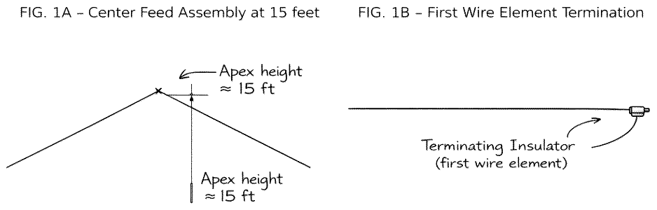

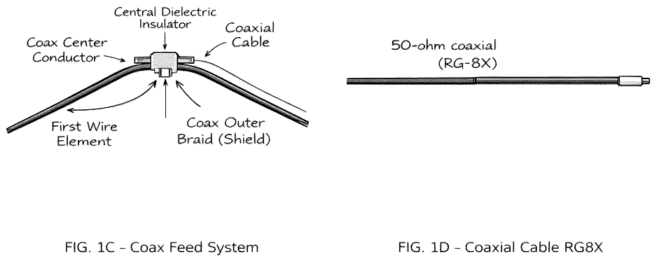

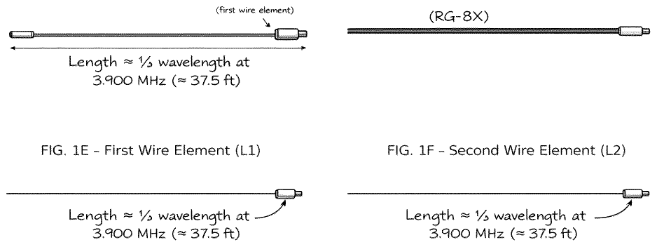

### DETAILED DESCRIPTION OF THE INVENTION

### 1. Antenna Structure

The wire dipole antenna includes a center insulator (1) located at the feed point. This feed point is where the antenna is connected to the transmission line, such as a coaxial cable. The dipole consists of two wire elements (2) extending from the center insulator towards the ends of the antenna, with each element having a length approximately equal to half the wavelength of the desired resonant frequency.

For operation at 3.900 MHz (75 meters), the total length of each wire element is approximately 37.5 feet (half the wavelength at 3.900 MHz). The antenna operates specifically within this 75-meter band, providing efficient radiation for frequencies in the 3.8 to 4.0 MHz range.

### 2. Low Apex Height

The novel feature of this design is the low apex height of 15 feet (approximately 1/16 wavelength at 3.900 MHz). This low apex height is achieved through the optimized arrangement of the wire elements and the placement of the center insulator at a relatively low elevation. This height allows the antenna to be installed in areas with space limitations while still maintaining effective radiation characteristics for 75-meter band operation.

### 3. Termination and Coaxial Connection

At the ends of the wire elements, terminating insulators (3) are installed. These insulators are used to secure the ends of the wire elements while providing a convenient connection point for the coaxial cable's braid (in FIG. 2) and center conductor (in FIG. 3). These termination points enable easy installation and maintain the antenna's efficient operation without excessive electrical losses or impedance mismatch.

### 4. Frequency Range and Bandwidth

The antenna is designed to operate exclusively in the amateur radio 75-meter band, with its primary resonance at 3.900 MHz. The antenna's design provides a wide bandwidth within this frequency range, ensuring low standing wave ratio (SWR) and efficient signal transmission and reception.

### 5. Mounting and Installation

The antenna can be mounted at a height of 15 feet on a mast or similar structure. Due to its low apex height, the antenna is particularly suited for installations where vertical space is limited or where aesthetic considerations are important. It can be deployed horizontally or slant-mounted, depending on the available space and required performance.

### Claims, One Through Seven

1. A wire dipole antenna for 75-meter high-frequency radio applications, comprising:
   a central center insulator (1) configured to receive an RF signal;
   two symmetrical wire elements (2) extending from the center insulator in opposite directions, wherein each wire element has a length of approximately half the wavelength at 3.900 MHz;
   a low apex height of 15 feet, corresponding to 1/16 wavelength at 3.900 MHz;
   means for terminating the wire elements at their ends with terminating insulators (3), where coaxial cable connections are made.
2. A wire dipole, wherein the wire elements are made from a material selected from the group consisting copper, aluminum, and alloys thereof.
3. A wire dipole antenna, wherein the antenna operates in the frequency range from 3.8 MHz to 4.0 MHz, with a primary resonance at 3.900 MHz.
4. A wire dipole antenna, wherein the center insulator is designed to accommodate a coaxial cable with a coax braid connected to the wire elements and a coax center conductor connected to the feed point.
5. A wire dipole antenna, wherein the antenna is designed to operate with a low standing wave ratio (SWR) across the 75-meter band.
6. A wire dipole antenna, wherein the antenna is configured to be installed at a height of 15 feet for optimal performance in the 75-meter band.
7. A wire dipole antenna, further comprising a mounting system for supporting the antenna in a vertical or slanted configuration.

### Operation of the Invention

The wire dipole antenna functions by converting the electrical signals from the radio transmitter into electromagnetic waves. The antenna's wire elements are specifically tuned to resonate efficiently at 3.900 MHz, within the 75-meter band. With the low apex height of 15 feet, the antenna's performance remains strong while minimizing space requirements, making it an ideal solution for environments where height constraints exist.

The design of the antenna ensures that it operates with minimal impedance mismatch, allowing for optimal signal transmission and reception. The terminating insulators at the ends of the wire elements allow for easy connection to the coaxial feed lines without introducing significant loss or distortion.

### Potential Advantages of the Invention

Compact Size: The low apex height makes it suitable for environments with limited vertical space.
High Efficiency: The antenna provides excellent efficiency and performance at 3.900 MHz, making it ideal for 75-meter band operations.
Easy Installation: The antenna can be easily installed in areas with height limitations, requiring minimal space for mounting.
Wide Bandwidth: The antenna offers wide frequency coverage with low SWR across the 75-meter band.
Versatility: The antenna is suitable for various radio communication systems, including amateur radio, emergency communications, and other high-frequency applications.

### Conclusion

The wire dipole antenna for 75-meter radio applications with a low apex height of 15 feet represents an innovative solution to the challenge of installing high-performance antennas in constrained spaces. This design provides exceptional efficiency in the 75-meter frequency range while maintaining a compact footprint. The antenna is easy to install and is particularly suited for environments where space limitations are a concern.

1. A wire dipole antenna comprising:
a pair of elongate conductive wire elements extending in opposite directions from a center feed region, each wire element having a free end and an inner end;
a center feed assembly positioned at the center feed region, the center feed assembly comprising:
a central dielectric insulator mechanically supporting the inner ends of the pair of wire elements; and
a coaxial feed line having a center conductor and an outer braid, the coaxial feed line terminating at a feed point adjacent the central dielectric insulator;
wherein the center conductor of the coaxial feed line is electrically connected to the inner end of a first wire element, and the outer braid of the coaxial feed line is electrically connected to the inner end of the second wire element, such that the pair of wire elements are differentially driven at the feed point;
wherein each wire element has a length of approximately one-half wavelength at a target operating frequency of approximately 3.900 MHz; and
wherein the pair of wire elements are arranged such that, when installed, the apex of the dipole is approximately 15 feet above ground.

2. The wire dipole antenna of claim 1, wherein the central dielectric insulator is formed of a non-conductive polymer material.

3. The wire dipole antenna of claim 1, wherein the antenna is configured to operate in a frequency range from approximately 3.8 MHz to approximately 4.0 MHz, with a primary resonance at approximately 3.900 MHz.

4. The wire dipole antenna of claim 1, wherein each wire element comprises a material selected from the group consisting of copper, aluminum, and alloys thereof.

5. The wire dipole antenna of claim 1, wherein the coaxial feed line is a 50-ohm coaxial cable, and wherein the outer braid is electrically connected to the second wire element via a short conductive lead adjacent the central dielectric insulator.

6. The wire dipole antenna of claim 1, wherein the pair of wire elements are arranged in a common plane extending outward from the center feed region.

7. (canceled)
